(19) United States
(12) Patent Application Publication
(10) Pub. No.: US 2013/0294891 A1
(43) Pub. Date: Nov. 7, 2013

(54) METHOD FOR THE GENERATIVE PRODUCTION OF A COMPONENT WITH AN INTEGRATED DAMPING ELEMENT FOR A TURBOMACHINE, AND A COMPONENT PRODUCED IN A GENERATIVE MANNER WITH AN INTEGRATED DAMPING ELEMENT FOR A TURBOMACHINE

(71) Applicants: Stefan Neuhaeusler, Thierhaupten (DE); Wilhelm Satzger, Munich (DE); Siegfried Sikorski, Munich (DE); Karl-Heinz Dusel, Unterschleissheim (DE); Hans-Christian Melzer, Jetzendorf (DE); Erwin Bayer, Dachau (DE)

(72) Inventors: Stefan Neuhaeusler, Thierhaupten (DE); Wilhelm Satzger, Munich (DE); Siegfried Sikorski, Munich (DE); Karl-Heinz Dusel, Unterschleissheim (DE); Hans-Christian Melzer, Jetzendorf (DE); Erwin Bayer, Dachau (DE)

(21) Appl. No.: 13/978,641

(22) PCT Filed: Jan. 10, 2012
(86) PCT No.: PCT/DE12/00012

§ 371 Date: Jul. 24, 2013

(30) Foreign Application Priority Data
Jan. 15, 2011 (DE) 10 2011 008 695.1

(51) Int. Cl. F01D 25/06; B23P 15/02

(52) U.S. Cl. CPC F01D 25/06; B23P 15/02
USPC 415/119; 29/889.7

(57) ABSTRACT

The invention provides a method for the generative manufacture of a component (1) with integrated damping for a turbomachine, in particular a gas turbine, having the following method steps: building up the component (1) in a generative manner, and introducing a damping material (2) into the component (1) during the method step of the generative building up of the component (1). The invention further provides a component (1) with integrated damping for a turbomachine, in particular a gas turbine, wherein the component (1) is built up in a generative manner, and the component (1) has a damping material (2) which is introduced into the component (1) during the generative building up of the component (1). The invention further provides a turbomachine, in particular a gas turbine, comprising such a component (1).

The present invention relates to a method for the generative manufacture of a component with integrated damping for a turbomachine, in particular a gas turbine, to a component with integrated damping for a turbomachine, in particular a gas turbine, and to a turbomachine, in particular a gas turbine, with such a component.

Although it can be applied to any turbomachine, the present invention and the problems it addresses are explained in more detail with reference to a gas turbine.

Turbine components that are subjected to vibrational and/or thermal loading must be of a very massive design in order to avoid premature failure of these components as a result of vibration fatigue failure. In order to achieve sufficient stiffness of the components, they are made with correspondingly great wall thicknesses. This leads to a high component weight. It is understandably endeavored to avoid this.

Accordingly, DE 10 2006 049 216 A1 describes a method for manufacturing a high-pressure turbine rotor, this turbine rotor being designed as a blisk (i.e. a bladed disk) and forming a radially inwardly arranged disk and a number of blades or airfoils protruding from this disk, the turbine rotor having an internal system of ducts for cooling and at least one portion of this turbine rotor being created by a generative manufacturing method.

DE 10 2006 022 164 A1 describes a method for stiffening a rotor element for production machining, the rotor element having at least one peripheral recess which is accessible from at least one side and has a radially outer lying bounding wall. The at least one recess is at least partially filled with a supporting structure of metal foam.

It is in each case a disadvantage of these arrangements that either no damping material is provided or that a damping material is only introduced in a further method step after the manufacture of the component. As a result, the components manufactured can only be manufactured in a cost-intensive and/or complex manner

On this basis, it is an object of the present invention to provide an improved method for manufacturing a component with integrated damping. This object is achieved according to the invention by a method with the features of patent claim 1 and/or by a component with the features of patent claim 10.

Accordingly, a method for the generative manufacture of a component with integrated damping for a turbomachine, in particular a gas turbine, is provided, having the following method steps: building up the component in a generative manner, and introducing a damping material into the component during the method step of the generative buildup of the component.

Furthermore, a component with integrated damping for a turbomachine, in particular a gas turbine, is provided, the component being built up in a generative manner, and the component having a damping material that is introduced into the component during the generative buildup of the component.

The basic concept of the present invention is that the damping material can be introduced into the component at the same time as the generative buildup of the component. This makes it possible for example to introduce the damping material into closed cavities of the component, and a rapid buildup of the component is possible without a subsequent method step of subsequently introducing the damping material.

Advantageous developments are provided by the subclaims.

According to a preferred development of the method, an unsolidified base material of the component is introduced as damping material. This ensures a particularly rapid buildup of the component, without a second material being introduced as damping material. This advantageously reduces the complexity of the method.

According to a further preferred development of the method, the component is built up at least in certain portions with a cavity. As a result, the component is advantageously built up in a particularly lightweight manner, whereby the application area of the method is extended.

According to a further preferred development of the method, the damping material is introduced into the cavity. As a result, the damping material is reliably accommodated in the component.

According to a further preferred development of the method, during the generative buildup of the component an integrated supporting and/or cooling structure is built up in the cavity. This increases the stiffness and strength of the component significantly.

According to a further preferred development of the method, the supporting structure is built up at least in certain portions with a cavity into which the damping material is introduced. As a result, both increased stiffness and improved damping behavior of the component are achieved.

According to a further preferred development of the method, during the generative buildup of the component a cooling bore is introduced into an outer wall of the component, to connect the cavity to an outer surface of the component. As a result, the discharge of cooling fluid from the cavity to the outer surface of the component is advantageously made possible.

According to a further preferred development of the method, during the generative buildup of the component a cooling-fluid-deflecting cooling bore entry of the cooling bore arranged on an inner surface of the cavity is formed, to deflect cooling fluid out of the cavity into the cooling bore. This makes specifically selective removal of cooling fluid from the cavity into the cooling bore possible.

According to a further preferred development of the method, during the generative buildup of the component a cooling bore exit of the cooling bore arranged on the outer surface of the component is formed tangentially in relation to the outer surface. As a result, the formation on the outer surface of a cooling film for cooling the component is advantageously made possible.

The invention is explained in more detail below on the basis of a preferred exemplary embodiment with reference to the accompanying figures of the drawing, in which:

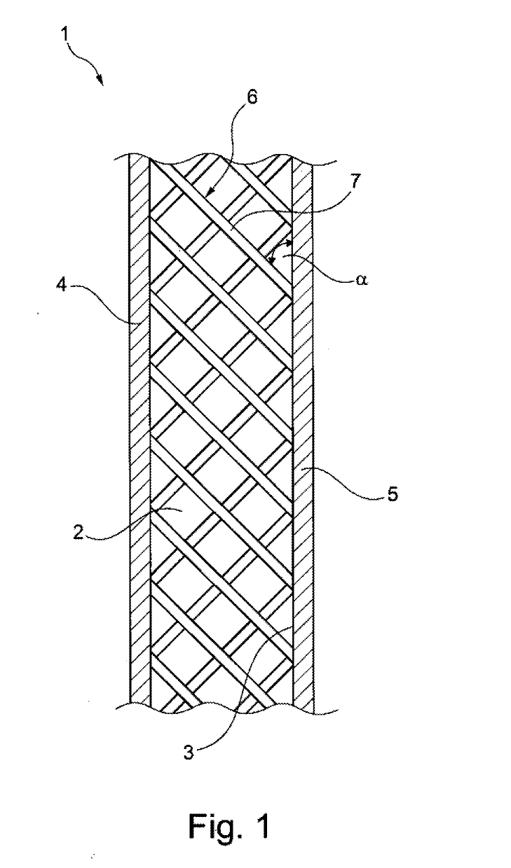

FIG. 1 shows a sectional view of a component according to a preferred exemplary embodiment of the present invention;

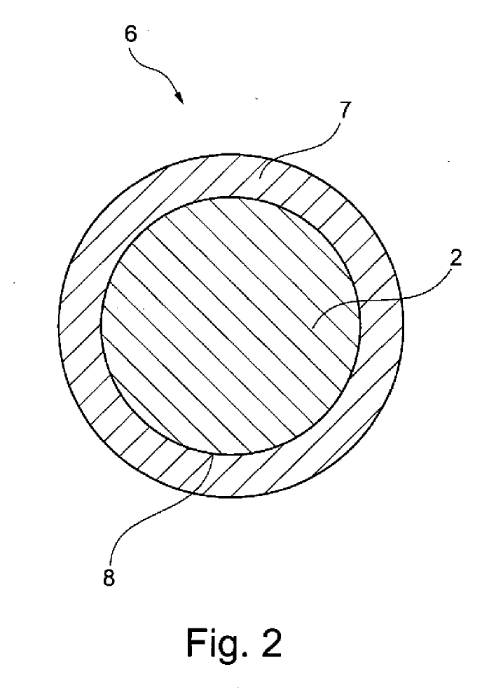

FIG. 2 shows a sectional view of a supporting structure according to a preferred embodiment of the present invention;

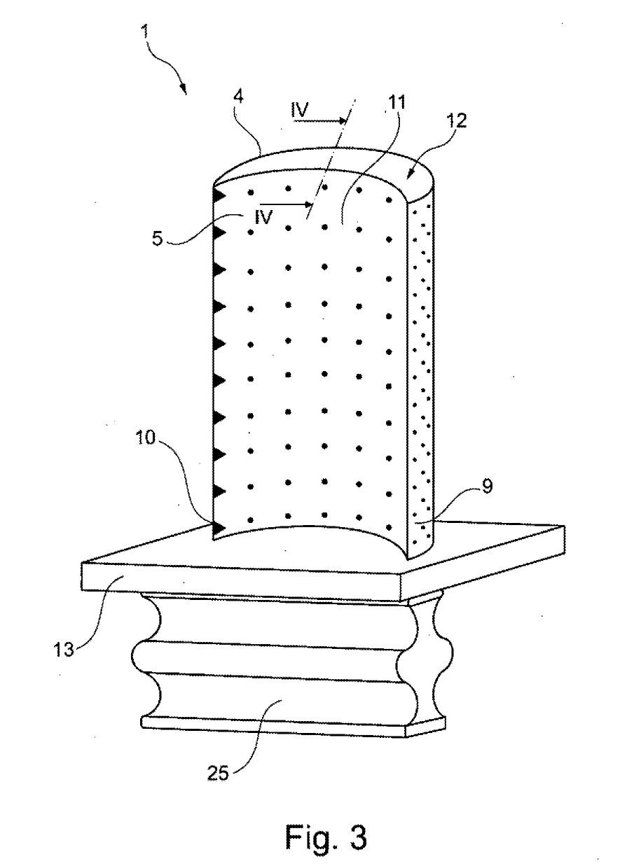

FIG. 3 shows a perspective view of a component according to a further preferred exemplary embodiment of the present invention;

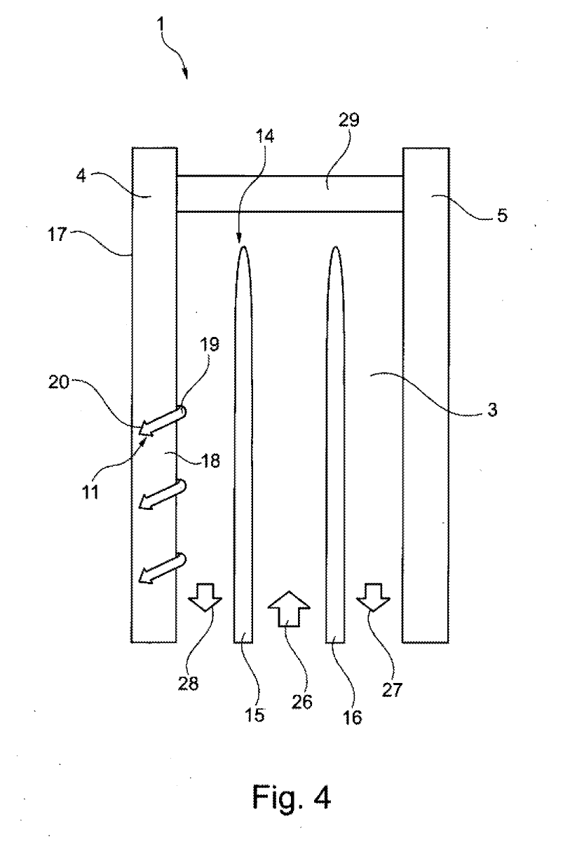

FIG. 4 shows a sectional view of the component according to the sectional line IV-IV as shown in FIG. 3;

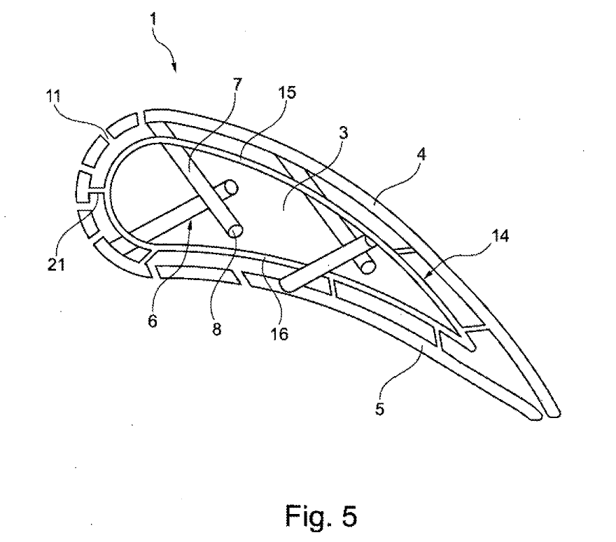

FIG. 5 shows a perspective view of a component according to a further preferred exemplary embodiment of the present invention;

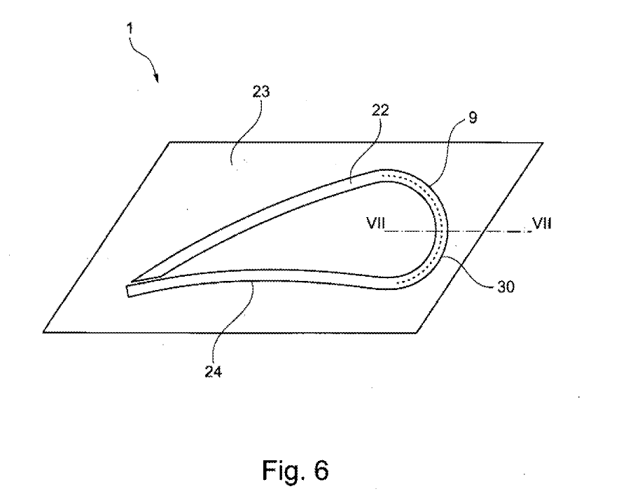

FIG. 6 shows a perspective view of a component according to yet another preferred exemplary embodiment of the present invention; and

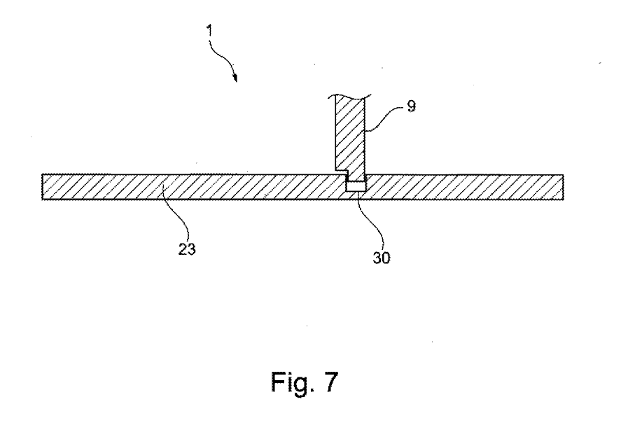

FIG. 7 shows a sectional view of the component according to the sectional line VII-VII as shown in FIG. 6.

In the figures of the drawing—unless otherwise stated—elements and features that are the same or functionally the same are provided with the same reference signs.

FIG. 1 illustrates a preferred exemplary embodiment of a component 1 with integrated damping. The component 1 is for example formed as a component of so-called flowpath hardware of a turbomachine, in particular a gas turbine. Flowpath hardware is understood as meaning for example components of the turbomachine that are arranged in a hot gas stream of the turbomachine, such as for example moving blades, stationary blades, a rotor, a stator, a cover shroud, housing portions or the like. The component 1 is preferably arranged in the hot gas stream of the turbomachine. The component 1 may alternatively be formed as a component of a compressor of a turbomachine; in this case, the component is not subjected to any hot gas loading. The component 1 is preferably built up from a metal material by means of a generative method. Used for example as generative methods are so-called laser engineered net shaping (LENS) and/or an electron beam melting method and/or a selective laser melting method and/or a laser forming method and/or a laser build-up welding method or the like. Any other desired generative method may also be used for building up the component 1 from a metallic material. For example, the component 1 is built up in the form of layers from a powdered base material of the component 1. For this purpose, the base material is initially unsolidified and, for the generative buildup of the component 1, is at least partially melted and thus solidified, for example by means of heat input. The integrated damping of the component 1 is preferably achieved by the introduction of a damping material 2 into the component 1 during the generative buildup of the component 1 from the base material. The damping material 2 is for example an unsolidified base material of the component 1. For this purpose, particularly after the generative buildup of the component 1, unsolidified, powdered base material is left in the component 1. Alternatively, the damping material is for example an adhesive or a ceramic slip, which for example can be set in its damping properties by the addition of hollow spheres, ceramic particles, glass spheres and/or the like, that is introduced into the component 1 during the generative buildup thereof Alternatively, the damping material 2 or additional damping material 2 may be introduced into the component 1 after the generative buildup thereof.

Preferably, the component 1 is built up at least in certain portions with a cavity 3. The cavity 3 is for example enclosed by outer walls 4, 5 of the component. Preferably, the damping material 2 is introduced into the cavity 3. This takes place during the generative buildup of the component 1, for example by unsolidified base material, for example powdered base material, not being removed from the cavity 3, or at least not completely removed, but left in it.

Preferably, during the generative buildup of the component an integrated, internal supporting structure 6 is built up in the cavity 3. The supporting structure 6 may act as a damping structure 6. The supporting structure 6 has for example a multiplicity of struts 7 running between the outer walls 4, 5 of the component 1, of which only one strut 7 is provided with a reference numeral. The struts 7 may for example be uniformly distributed in the cavity 3 or, depending on the loading of the component 1, be arranged in greater or smaller number in specific portions of the component 1 and have variable angles of inclination a in relation to the outer walls 4, 5 and for example variable cross sections. The struts 7 may cross and/or intersect one another. The supporting structure 6 may be formed in the form of cells, for example with a honeycomb structure, an octahedral structure and/or a tetrahedral structure or the like. A tetrahedral or octahedral structure has the advantage that there is no preferential direction. For example, the supporting structure 6, in particular the struts 7 or the cell structure, may, as illustrated in FIG. 2, be built up at least in certain portions with a cavity 8, into which the damping material 2 is introduced. Titanium, nickel superalloys, tungsten-molybdenum alloys or the like are used for example as materials for the component 1.

FIGS. 3 and 4, to which reference is made at the same time hereinafter, illustrate a further preferred exemplary embodiment of a component 1. The component 1 is for example formed as a turbine blade 1, in particular as a high-pressure turbine blade 1 or as a low-pressure turbine blade 1, of a turbomachine. Preferably, the turbine blade 1 is formed as a moving blade 1. The moving blade 1 has for example an airfoil 12 with a leading edge 9 and a trailing edge 10. In a plan view of the moving blade 1, a profile of the airfoil 12 runs from the leading edge 9 via an upper outer wall 4 to the trailing edge 10. From the trailing edge 10, the profile of the moving blade 1 runs via a lower outer wall 5 back to the leading edge 9. The upper outer wall 4 is preferably formed as the suction side 4 and the lower outer wall 5 is preferably formed as the pressure side of the moving blade 1. The outer walls 4, 5, the leading edge 9 and/or the trailing edge 10 preferably have a multiplicity of cooling bores, in particular cooling air bores, of which only one cooling bore 11 is provided with a reference numeral in FIG. 3. The cooling bores are preferably distributed in any way desired on the moving blade 1.

Apart from the airfoil 12, the moving blade 1 has a blade root 13. The blade root 13 carries the airfoil 12. The blade root 13 has a platform, the airfoil 12 being arranged on one side of the plate of the platform and a dovetail connection 25 with a preferably firtree-shaped cross section being provided on the other side of the plate of the platform. The dovetail 25 serves for the nonpositive and/or positive connection of the moving blade 1 to a rotor hub of a turbomachine. The moving blade 1 may also be built up in a generative manner in one piece with a rotor hub.

The moving blade 1 is preferably formed with a cavity 3. A cooling structure 14 is preferably formed in the cavity 3. The cooling structure 14 is for example formed in the form of walls 15, 16, which guide a cooling fluid, particular cooling air, in the cavity of the moving blade 1. The walls 4, 5 run for example in the cavity 3 parallel to the outer walls 4, 5 of the moving blade 1. For example, the cooling structure 14 guides cooling air in the direction of the arrows 26-28 into a region of a blade tip 29 that is particularly subjected to thermal loading and away from it again. The cooling structure 14 may be formed as a cooling/supporting structure 14. By analogy with the exemplary embodiment of the component 1 according to FIGS. 1 and 2, damping material 2 may be provided for example in the cooling structure 14, to realize integrated damping of the moving blade 1.

During the generative buildup of the moving blade 1, the cooling bores are for example introduced into the outer walls 4, 5 of the moving blade 1. For example, the outer wall 4 has the cooling bore 11. The cooling bore 11 connects the cavity 3 to an outer surface 17 of the moving blade 1. During the generative buildup of the moving blade 1, the cooling-fluid-deflecting cooling bore entry 19 of the cooling bore 11 is preferably formed on an inner surface 18 of the cavity 3. The cooling-fluid-deflecting cooling bore entry 19 is preferably formed as a shell-shaped cooling bore entry 19 and deflects cooling fluid out of the cavity 3 into the cooling bore 11. Each cooling bore of the moving blade 1 may have an individually formed cooling bore entry 19. The cooling bore 11 may follow a path in the outer wall 4 that is curved, twisted or curved and/or twisted in certain portions. During the generative buildup of the moving blade 1, a cooling bore exit 20 arranged on the outer surface 17 is preferably made in such a way that it is arranged tangentially in relation to the outer surface 17. The cooling bore exit 20 preferably has a funnel form, the funnel form being open toward the outer surface 17 of the component 1. On account of the tangential arrangement of the cooling bore exit 20, there forms on the outer surface 17 a cooling film, which protects the moving blade 1 from direct contact with hot gas. Each cooling bore may have an individually made cooling bore exit 20. By analogy with the exemplary embodiment of the component 1 as shown in FIGS. 1 is 2, the moving blade 1 preferably has an integrated supporting structure 6, which has for example struts 7 or cell structures such as honeycomb, octahedral and/or tetrahedral structures. As damping material 2, preferably unsolidified base material of the component 1 is left at least partially in the cavity 3 of the moving blade 1 or in the cavity 8 of the supporting structure 6. Furthermore, the component 1 may for example be formed as a combustion chamber 1, it being possible for the cooling bore 11 with the tangential cooling bore exit 20 to be used for wall cooling of an inner wall of the combustion chamber 1.

According to a further exemplary embodiment as shown in FIG. 5, the component 1 may be formed as a stationary blade 1. A cooling structure 14 of the stationary blade 1 preferably has in addition to cooling-air-guiding walls 15, 16 for example webs, of which only one web 21 is provided with a reference numeral. The webs serve for supporting the walls 15, 16 in the cavity 3 and for guiding cooling air. The cooling structure 14 is consequently preferably formed as a double-walled cooling duct, in order to direct the coolest air with preference to regions of the stationary blade 1 that are most subjected to hot gas.

Furthermore, the stationary blade 1 preferably has a supporting structure 6, which is formed for example in the form of struts 7 by analogy with the exemplary moment of the component 1 as shown in FIGS. 1 and 2. The arrangement and the number of struts 7 is as desired. The struts 7 may for example intersect or cross one another. Preferably, the supporting structure 6, in particular the struts 7, has a cavity 8, in which damping material 2 is introduced. The damping material 2 is preferably introduced into the cavity 8 and/or into the cavity 3 during the generative buildup of the moving blade 1. As damping material, preferably unsolidified base material of the component 1 is left in the cavity 3 of the component 1 and/or in the cavity 8 of the supporting structure 6. The supporting structure 6 is for example built up as an octahedral structure 6 or as a tetrahedral structure 6 without a preferential direction. For example, the side walls 4, 5 of the stationary blade 1 are manufactured as parts of a lattice structure with a covering skin for weight reduction.

FIGS. 6 and 7 illustrate yet a further preferred exemplary embodiment of the component 1. The component 1 is preferably formed as a stationary blade 1 with an integrated cover shroud 23. The cover shroud 23 preferably has a hollow-cylindrical form, a multiplicity of stationary blades 1 being arranged spaced radially apart from one another on an outer surface of the hollow-cylindrical form of the cover shroud 23. An outline of a stationary blade 1 is represented in FIG. 6. The stationary blade 1 is preferably built up in a generative manner according to the exemplary embodiments of the component 1 as shown in FIGS. 1 to 5, with preference with an internal supporting structure 6 and with integrated damping. The stationary blade 1 and the cover shroud 23 are preferably created in a generative manner together and are of one piece. Formed between the stationary blade 1 and the cover shroud is a joint 24. In a region 22, illustrated by a dotted line, of the joint 24 at a leading edge 9 of the stationary blade 1, the latter is not integrally connected to the cover shroud 23. The joint 24 is formed in the portion 22 as a z-joint 30. The z-joint 30 decouples the stationary blade 1 from the cover shroud 23 in the region 22. In the region of the leading edge 9, the highest mechanical stresses caused by thermomechanical loads occur on a stationary blade 1. Thermomechanical material fatigue (“thermomechanical fatigue”, TMS) may occur in this region. On account of the decoupling of the leading edge 9 from the cover shroud 23 by means of the z-joint 30, the stationary blade 1 can expand and contract again without the massive cover shroud 23 hindering this movement. As a result, the stress loading is reduced and crack formation in the leading edge 9 of the stationary blade 1 is prevented or delayed. The fact that the stationary blade 1 is recessed in the cover shroud 23 in a certain portion, in the region of the z-joint, means that the z-joint does not cause any disturbance of the hot gas flowing onto the leading edge 9.

By means of the component created according to the invention, an increase in the cooling efficiency of generatively manufactured high-pressure turbine and low-pressure turbine blades is possible. Furthermore, the component weight of the component is reduced, along with the same or improved structural strength, by reducing tolerances in comparison with a cast variant. The tangential exiting of the cooling bores improves the cooling of hollow high-pressure turbine blades and combustion chambers. The deflecting cooling bore entry makes it possible for the throughput of each individual cooling bore to be controlled in accordance with requirements, by the cooling bore entry being geometrically designed appropriately. The integrated damping of the component reduces the sensitivity to vibration, and thereby increases the service life of the component.

1.-11. (canceled)

12. A method for the generative manufacture of a component with integrated damping for a turbomachine, wherein the method comprises building up the component in a generative manner, and introducing a damping material into the component during the generative buildup of the component.

13. The method of claim 12, wherein an unsolidified base material of the component is introduced as damping material.

14. The method of claim 12, wherein the component is built up at least in portions thereof with a cavity.

15. The method of claim 14, wherein the damping material is introduced into the cavity.

16. The method of claim 14, wherein during the generative buildup of the component an integrated supporting and/or cooling structure is built up in the cavity.

17. The method of claim 15, wherein during the generative buildup of the component an integrated supporting and/or cooling structure is built up in the cavity.

18. The method of claim 17, wherein the supporting structure is built up at least in portions thereof with a cavity into which the damping material is introduced.

19. The method of claim 14, wherein during the generative buildup of the component a cooling bore is introduced into an outer wall of the component, the cooling bore connecting the cavity to an outer surface of the component.

20. The method of claim 19, wherein during the generative buildup of the component a cooling-fluid-deflecting cooling bore entry of the cooling bore arranged on an inner surface of the cavity is formed, to deflect cooling fluid out of the cavity into the cooling bore.

21. The method of claim 19, wherein during the generative buildup of the component a cooling bore exit of the cooling bore arranged on the outer surface of the component is formed tangentially in relation to the outer surface.

22. The method of claim 20, wherein during the generative buildup of the component a cooling bore exit of the cooling bore arranged on the outer surface of the component is formed tangentially in relation to the outer surface.

23. A component with integrated damping for a turbomachine, wherein the component has been built up in a generative manner and comprises a damping material that has been introduced into the component during the generative buildup of the component.

24. A turbomachine which comprises the component of claim 23.

25. The turbomachine of claim 24, which is a gas turbine.
